(19) United States
(12) Patent Application Publication
(10) Pub. No.: US 2023/0054705 A1
(43) Pub. Date: Feb. 23, 2023

(54) SOFTWARE-DEFINED MODULAR ENERGY SYSTEM DESIGN AND OPERATION

(71) Applicant: Energy Internet Corporation, Saratoga, CA (US)

(72) Inventors: Shankar Ramamurthy, Saratoga, CA (US); Mohan J. Kumar, Aloha, OR (US)

(21) Appl. No.: 17/980,600

(22) Filed: Nov. 4, 2022

Related U.S. Application Data
(63) Continuation-in-part of application No. 16/747,843, filed on Jan. 21, 2020.
Application No. 16/747,843 is a continuation-in-part of application No. 16/378,243, filed on Apr. 8, 2019, now Pat. No. 10,947,899.
Application No. 16/378,243 is a continuation-in-part of application No. 16/118,886, filed on Aug. 31, 2018, now Pat. No. 10,725,441.
(60) Provisional application No. 63/275,982, filed on Nov. 5, 2021.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.
(60) Provisional application No. 62/654,859, filed on Apr. 9, 2018.

(51) Int. Cl. G05B 19/418

(52) U.S. Cl. CPC G05B 19/41885; G05B 19/41845

(57) ABSTRACT

Disclosed techniques include software-defined modular energy system design and operation. A set of energy system plant requirements for a mechanical system is obtained. The mechanical system comprises a plurality of components. The plurality of components includes a liquid piston heat engine. One or more processors are used to optimize a plant description. The plant description is based on the set of energy system plant requirements and a library of components. Processors are used to design a specification for an energy system plant. The specification includes components from the library of components and couplings among the components. An energy system plant design is output based on the specification. The design enables energy system plant construction. The energy system plant design is simulated to enable a reliability analysis and to provide feedback about the plant description. The simulating generates operational controls to enable energy system plant functionality.

### RELATED APPLICATIONS

This application claims the benefit of U.S. provisional patent application “Software-Defined Modular Energy System Design And Operation” Ser. No. 63/275,982, filed Nov. 5, 2021.

This application is also a continuation-in-part of U.S. patent application “Energy Management Using a Converged Infrastructure” Ser. No. 16/747,843, filed Jan. 21, 2020, which claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

The U.S. patent application “Energy Management Using a Converged Infrastructure” Ser. No. 16/747,843, filed Jan. 21, 2020 is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy system design and more particularly to software-defined modular energy system design and operation.

### BACKGROUND

The vicissitudes of geopolitics, global pandemics, and war directly impact the prices and availability of traditional energy sources. Global supply chain interruptions, punishing sanctions, and tit-for-tat reprisals are causing energy shortages, wild price fluctuations, and international concerns that nations will not be able to obtain sufficient energy sources required to support transportation, electrical generation and distribution, and heating and cooling needs. Traditional energy sources are further interrupted by unplanned events such as hurricanes and blizzards, as well as planned events including routine maintenance. Whatever the causes, when energy supplies are interrupted, nations and their people suffer. Worsening an already critical situation is the fact that energy demands are increasing globally at an ever increasing rate. To remedy the energy generation and distribution quandaries, many nations are developing and undertaking plans to transition from traditional energy sources such as fossil fuels to renewable sources such as solar and wind energy. These transitions have environmental advantages as well because they avoid environmental damage due to oil drilling, coal mining, and carbon emissions from the combusted fuels. The benefits notwithstanding, these renewable sources alone are not yet able to replace oil, coal, and natural gas generation facilities. Further, the renewable sources only produce energy when the sun is shining, the wind is blowing, and ocean waves are present, among other intermittent actions. Other countries are addressing their energy demands by building new generation facilities that burn fossil fuels. Many fear the consequences to the environment from increasing carbon emissions of these new and the already existing carbon producers.

Worldwide energy demand continues to increase due to population growth and development of regions that previously lacked infrastructures for transportation and electrical energy distribution. Further, the motivation to replace carbon-based fueled vehicles with electric vehicles dictates that vehicle operators will require greater amounts of electricity to power their vehicles. Electricity source access is presently hindered by outdated electrical distribution systems that are unable to support the increased demand. Economic growth also increases energy demand. The increase of retail, public transportation, manufacturing, and many other activities all require greater amounts of energy. Thus, energy stakeholders including energy producers and energy consumers struggle to address their present energy needs while they plan for expanded and future energy requirements. The energy producers include traditional and renewable energy sources, while energy consumers include government agencies, businesses and industries, and domestic consumers. One popular technique for balancing energy production with energy demand is to reduce energy demand. Socially and environmentally conscious energy consumers actively reduce their energy consumption and commensurate cost through energy conservation, installation of energy efficient lighting and appliances, and insulation of buildings. These conservation measures are driven by powerful environmental and economic thinking. However, the conservation efforts remain heavily outpaced by the increasing energy demand, resulting in what many analysts proclaim an energy crisis. Addressing increasing energy demand is clearly a complex and multifaceted problem. Increased demand for and overconsumption of energy strains natural and renewable resources alike, resulting in fuel shortages, higher energy costs, and increased environmental destruction and pollution.

### SUMMARY

Energy demands continue to expand as worldwide energy usage increases. The requirement for a reliable and resilient energy supply, as well as the need for grid modernization, further complicate energy production and delivery. Access to diverse and secure energy sources is critical. Clean and inexpensive energy is universally desired, not just in urban areas, but also in remote locations where micro-grid solutions can be favorable. Energy generation and storage together provide a solution to these energy needs. Generation and storage technologies provide backup power, supply level power loads, and offer energy management, all of which can strengthen and stabilize the power grid. However, the industrial scale designs and the architectures of energy generation and storage systems are highly labor intensive. Programmed or coded control of energy generation and storage is developed for a specific implementation and cannot easily adapt to changing sets of circumstances including dynamic loads, operations, or mixes of generation and storage components. Any change to the control system requires further software development and system validation. These requirements limit the scalability, extensibility, and adaptability of the control system.

A computer-implemented method for energy system design is disclosed comprising: obtaining a set of energy system plant requirements for a mechanical system, wherein the mechanical system comprises a plurality of components, wherein the plurality of components includes a liquid piston heat engine; optimizing, using one or more processors, a plant description, wherein the plant description is based on the set of energy system plant requirements and a library of components; designing, using one or more processors, a specification for an energy system plant, wherein the specification includes components from the library of components, along with couplings among the components; and outputting an energy system plant design, based on the specification, wherein the design enables energy system plant construction. Further, the energy system plant design is simulated. The simulating enables a reliability analysis of the specification for the energy system plant. The simulating provides feedback about the plant description, such as meeting design specifications, ensuring availability of components such as the liquid piston engine, and so on. The simulating generates operational controls. The operational controls enable energy system plant functionality.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for software-defined modular energy system design and operation.

FIG. 2 illustrates an energy internet (EI) platform.

FIG. 3 is a block diagram for energy management.

FIG. 4 illustrates an energy internet block diagram.

FIG. 5 shows a software-defined liquid piston heat engine (LPHE).

FIG. 6 illustrates a desalination system with brine recovery.

FIG. 7 shows a software-defined machine (SDM) application programming interface (API).

FIG. 8A illustrates a logical model of a liquid piston heat engine (LPHE) to pressurize a liquid.

FIG. 8B illustrates a logical model of a liquid piston heat engine.

FIG. 9 shows example power distribution.

FIG. 10 is a system diagram for software-defined modular energy system design and operation.

### DETAILED DESCRIPTION

Techniques for design and operation of software-defined modular energy systems are disclosed. A high-level language or a description language, such as a hardware description language, is used for control of software-defined modular machines. The modular machines can be mechanical in nature. The modular machines can comprise non-mechanical elements, such as in an electrical machine. The modular machines can be based on a liquid piston heat engine which can be used for energy conversion, storage, recovery, and generation. The various daily energy demands, both large and small, of individuals, households, small businesses, farms, manufacturing facilities, laboratories, governments, and so on, are met by many energy generation techniques that are in wide usage. Traditional energy generation techniques have been based on using nuclear sources, burning fossil fuels, tapping natural resources such as hydro or geothermal sources, and so on. As energy usage has continued to surge, and energy consumers have clamored for energy from alternative and renewable sources, energy generation has also expanded using techniques based on solar, wind, wave action, tidal action, biofuels, biogas, geothermal, and so on. Perhaps the principal obstacle to wider adoption of these latter and other renewable sources of energy is the intermittent nature of the sources. Windless days and nighttime hours affect energy generation based on wind and solar sources, respectively.

Some energy sources are available continuously while others are not. Energy with intermittent availability or energy in excess of load requirements at a given time can be captured. The captured energy can be stored or cached when the energy is being produced. The energy can be extracted and used at a later time for energy generation to meet an energy shortfall. A similar strategy can be used based on price, where energy is stored when production cost is low, then later extracted when the energy production cost is high. The stored energy can be used in combination with other energy sources, such as grid power or microgrid (local) power, to meet energy demands at given times of high demand. Storage can include a period of time, where the period of time can be a short-term basis or a long-term basis. Regardless of energy conversion technique, energy losses are introduced when energy is converted from one energy type to another energy type. Further losses occur when storing energy, extracting energy, generating energy, routing energy, etc. Minimizing the energy losses is critical to any energy storage and retrieval/recovery technique. Electrical energy storage is possible based on mature technologies such as sealed lead acid storage battery technologies, but the high costs of the immense battery banks required for such storage are prohibitive in terms of up-front investment and maintenance expenses. Further, batteries are problematic for long-term storage purposes because of charge leakage.

A liquid piston heat engine can be used with other components, including pressure vessels, valves, smart valves, turbines, and/or pumps, for energy storage and recovery. High-pressure vessels can be used to compress a gas within the vessel by pumping a liquid into the high-pressure vessel. Various types of liquids can be used to accomplish the compression. The liquids can include water, a specialized fluid such as Freon™, liquid air, liquid nitrogen, and so on. The compressed gas can be stored in a tank, an underwater bladder, unused oil infrastructure, and the like. The compressed gas can be stored in a storage reservoir such as an underground cavern or an aquifer. The compressed gas can be stored for a time basis such as a short-term basis or a long-term basis. When the energy represented by the stored compressed gas is needed to meet scheduled energy demands, to meet energy shortfalls, etc., then the compressed gas can be extracted from the storage reservoir. However, the pressure at which the gas is stored can be too high to directly operate a piece of equipment such as a turbine. The gas that is extracted from the storage reservoir can be directed to a second high-pressure vessel. Similar to the first high-pressure vessel, the second high-pressure vessel can contain a gas that can be used to accomplish a gas pressure within the second high-pressure vessel. The fluid within the second high-pressure vessel can be used to spin the turbine to generate energy such as electrical energy.

Energy such as generated electrical energy can be stored in various energy forms. The energy can be stored as electrical energy, mechanical energy, and so on. The energy can further be stored as a compressed gas, a pressurized liquid, and so on. The stored energy within the compressed gas can be later extracted by directly or indirectly spinning a turbine. The energy storage and extraction are most efficient when the pressurizing the gas is substantially isothermal. Substantially isothermal pressurizing or depressurizing of the gas can be accomplished by spraying a liquid into the high-pressure vessel. The injected liquid can be heated or cooled using heat exchangers to maintain substantially isothermal operation. The energy that is stored can be received from a wide diversity and disparity of energy sources. Energy can be stored when the amount of energy available from the points of generation exceeds the energy demand at the time of energy generation. The energy can be stored for a period of time. The energy storage can include gas-based energy storage using high-pressure vessels. The energy storage can include electrical energy storage using batteries or capacitors. The stored energy can be provided after a period of time to meet energy demands of current loads, dynamic loads, seasonal loads, and the like. Gas pressurized using high-pressure vessels can be stored in storage reservoirs for a time basis including short-term and long-term time bases. The storage and the extraction of the energy can be controlled by a processor-based energy management system. The processor-based energy management system can be implemented based on a software-defined machine. Managing the obtaining, connecting, providing, and delivering of energy is a complex and highly challenging task. Energy management can be influenced by many factors such as seasonal factors including the weather, variable energy generation pricing schemes, wildly varying energy demand, and so on. Energy management can be further complicated by an expanding energy customer base, quickly changing customer energy demands, requirements of service level agreements (SLAs), energy policies, etc. Despite the growing use of renewable energy resources such as solar, wind, wave action, tidal, geothermal, biogas, and the like, two significant challenges remain: the amount of energy produced by a given renewable energy source is highly variable, and the availability of the renewable energy source is inconsistent. As an example, wind energy is only available when wind is present, solar energy only when the sun is shining, wave action energy only when there is wave action, and so on.

Other disclosed techniques include design and control of mechanical machines based on software-defined modular energy systems. The control of a software-defined machine can include the configuring, or the configuration involved, in machine definition. The software definition can be based on a description language, which can include a general-purpose language or a hardware description language (HDL). A software-defined machine can be used for energy management. Energy can be obtained locally from a microgrid or from farther afield using a grid such as a utility grid. The energy can be derived from conventional generation sources, renewable sources, etc. The derived energy can be stored in various energy forms. The stored energy can be used for energy generation at a later time. The energy can be generated using fuels such as coal, natural gas, or nuclear sources; using hydro power or geothermal energy; using renewable sources such as solar, wind, tidal, wave-action, biofuels, or biogas; using pump-turbine sources such as compressed air, steam, or ice; using backup power sources such as diesel-generator (DG) sets; and so on. Access to a fluid-based local energy transfer distribution network is obtained. The energy transfer distribution can be based on one or more fluids, where the fluids can include water, liquid air, a specialty liquid such as Freon™, etc. The fluid-based local energy transfer distribution network can include at least two heterogeneous fluids. The energy transfer within the local energy transfer distribution network can be accomplished using multiple phases. The fluid-based local energy transfer distribution network can include a homogeneous fluid in liquid and gaseous phases.

A set of energy system plant requirements is obtained for a mechanical system comprising a plurality of components that includes a liquid piston heat engine (LPHE). The energy system plant requirements can include power generation capacities, power load requirements, storage requirements, distribution requirements, seasonal adjustments, and so on. The liquid piston heat engine can use a high-pressure gas to pressurize a liquid, a high-pressure liquid to compress a gas, and so on. The compressing the gas can accomplish liquefaction of the gas. The components within the plurality of components can include pressure vessels, valves, smart valves, turbines, pumps, and so on. The mechanical system can be based on energy storage and generation assemblies. The energy storage and generation assemblies can include a pump-turbine and a pressure vessel. At least one of the one or more fluid-based energy storage and generation assemblies can include a pump running at an optimum performance-pressure point. The liquid piston heat engine-based energy storage and generation assemblies can be parts of a larger energy management system that can include a large-scale energy storage subsystem. The large-scale energy storage subsystem can store electrical energy, potential energy, thermal energy, kinetic energy, chemical energy, etc. A hardware design for a mechanical system including a plurality of components that comprises a liquid piston heat engine is obtained. Couplings are described between the plurality of components. A plurality of layers is defined for the mechanical system. The mechanical system that comprises the liquid piston heat engine across the plurality of layers, based on the couplings between the plurality of components, is implemented.

Fluid-based energy from the energy storage and generation assemblies is delivered to the fluid-based local energy transfer distribution network. The delivering is based on an energy control management system executing on one or more processors. The delivering can include providing local fluid-based services, where the local fluid-based services supply local consumer applications. The consumer application can include a water nozzle, an air nozzle, a water Venturi function, an air Venturi function, a vacuum supply, space heating, a fluid-based rotation, space cooling, hot water, or cold water. The energy control management system uses supply profiles and demand profiles to adjust the delivering. The energy control management system provides valve control information to the one or more fluid-based energy storage and generation assemblies. The obtaining, the connecting, the providing, and the delivering comprise an energy internet converged infrastructure.

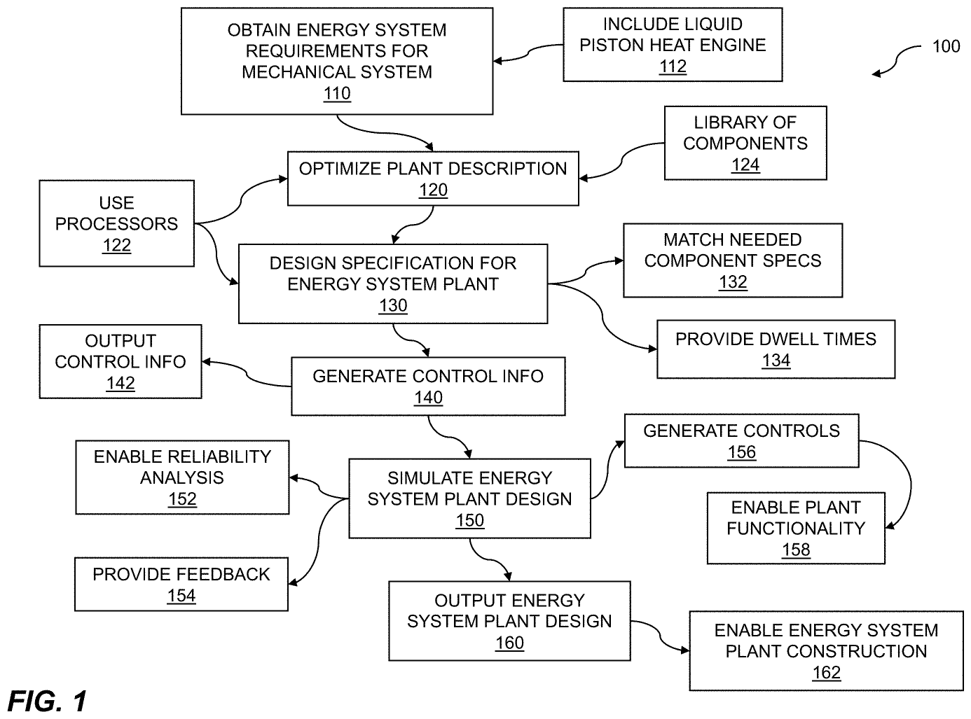

FIG. 1 is a flow diagram for software-defined modular energy system design and operation. The modular energy system designs are based on machines including mechanical and electrical machines. The software-defined modular machines can include machines for energy storage, generation, and management. The energy storage, generation, and management can be based on one or more assemblies, where the one or more assemblies can include fluid-based energy storage and generation assemblies. The fluid-based energy storage and generation assemblies can include a liquid piston heat engine (LPHE). The fluid-based energy storage and generation assembly can include multiple pressure vessels, parallel pipes to accommodate fluid expansion or compression, etc. The fluid can include water, liquid air, liquid nitrogen, and the like. The fluid can be used to compress a gas such as air or nitrogen, a specialty gas such as Freon™, and so on. The fluid can be used to move a liquid, such as by using the fluid to spin a pump-turbine. The pump-turbine can be used to move the liquid to create hydraulic head. The fluid in which energy is stored can be used to generate energy. The fluid can be used to spin a turbine, a pump-turbine, and the like. The fluid-based energy can include hot air, liquid air, cold air, or vacuum services. The fluid-based energy storage and generation assemblies can be parts of a large energy storage and generation subsystem. The energy storage and generation subsystem can include further assemblies for storing energy in other forms. The further energy storage and generation subsystems can include multiple batteries or capacitors, pressurized storage elements such as high-pressure water, pressurized air, steam, ice-water slurry, and the like.

The flow 100 includes obtaining a set of energy system plant requirements 110 for a mechanical system. The mechanical system includes a plurality of components. The system can further include a plurality of electrical components. In embodiments, the components can include pressure vessels, valves, turbines, pumps, pump-turbines, and the like. The components can further include electrical components such as batteries, capacitors, switches, etc. In the flow 100, the plurality of components includes a liquid piston heat engine (LPHE) 112. An LPHE can operate using a gas such as air and one or more liquid pistons (LPs). The liquid pistons can be used to replace mechanical pistons. The gas and the liquid can be chosen to minimize diffusion between or dissolution of the gas and the liquid in the piston. The gas can be used to pressurize the liquid, and the liquid can be used to compress the gas. Couplings between the plurality of components are described. The couplings can include pipes for fluids or gases, wires for electrical charge, valves or smart valves for gas and liquid transfer, and so on. The modular energy system can comprise a hierarchy of layers defined for the mechanical system. The layers can include layers of abstraction, where the layers of abstraction can include low level layers of abstraction, detailed layers of abstraction, layers that can describe modules or assemblies, high levels of abstraction that can describe the function of the mechanical system, and the like.

In embodiments, the set of energy system plant requirements can include a plurality of constraints for the mechanical system. The constraints for the mechanical system can include cost, energy system plant size (e.g., must fit within an area of a number of square meters), an availability metric, a reliability metric, and so on. In other embodiments, the set of energy system plant requirements comprises a plurality of constraints for the components. The constraints for the components can include cost of the components, availability, capacity, reliability, redundancy, and the like. In further embodiments, the set of energy system plant requirements can include a plurality of goals for the mechanical system. A goal for the mechanical system can include an application, a purpose, an end product, etc. In embodiments, the plurality of goals can include a primary goal and a secondary goal. The primary goal and the secondary goal can be dependent on one another. The secondary goal can include a byproduct of the primary goal. In embodiments, the primary goal can include desalination. The desalination can remove salt, minerals, contaminants, etc. from salty or brackish water. The desalination can be accomplished using a reverse osmosis technique. In other embodiments, the secondary goal includes gas compression. The gas compression can be used to store pressurized gas for liquefaction, and so on.

The mechanical system is the basis for an energy system plant design (discussed below). The mechanical system comprises the liquid piston heat engine and a plurality of hierarchical layers based on the couplings between the plurality of components. The implementing the mechanical system can include outputting an energy system plan design. The design can be outputted as a file of code based on a high-level language, a hardware description language, etc. The hardware description language enables a user to describe one or more desired functions of the machine using algebraic or Boolean expressions. As a result, the implementation of the mechanical machine can be quickly and easily modified simply by changing the code. The implementing includes matching needed component specifications with available components. The available components can include components that have not been allocated to another machine, components not offline for maintenance or repair, etc. The implementing can include detailed operational information. The implementing includes providing valve open times, redundancy definitions, or design envelope parameters. The design envelope parameters can be based on power generation capacity, a maximum desalination capability, and the like.

The flow 100 includes optimizing a plant description 120. The plant description can include code that can describe an energy system plant. The optimizing can be based on an objective function, where the objective function can be calculated to minimize cost, component count, redundancy, and so on. The objective function can be further calculated to maximize power output, efficiency, reliability, and the like. In the flow 100, the optimizing can be accomplished using one or more processors 122. The processors can include stand-alone processors, processors embedded in semiconductor circuits or chips, processor cores within application-specific chips or programmable chips, etc. The processors can include homogeneous processors and heterogeneous processors. A variety of optimization techniques can be used for the optimizing. The optimization techniques can include continuous and discrete optimization, constrained and unconstrained optimization, deterministic and stochastic optimization, etc. In the flow 100, the plant description that is optimized is based on the set of energy system plant requirements and a library of components 124. The library of components can include mechanical components such as pressure vessels, valves, turbines, or pumps; electrical components such as batteries, capacitors, and switches; etc.

The flow 100 includes designing a specification 130 for an energy system plant. The design of the specification can include a “blueprint” for an energy system plant. The blueprint can be based on code such as hardware description code. In the flow 100, the designing the specification can be accomplished using one or more processors 122. The design of the specification can include a “parts list” of components. In embodiments, the specification includes components from the library of components, along with couplings among the components. As discussed previously and throughout, the components can include one or more of pressure vessels, valves, smart valves, turbines, pumps, tanks, cryogenic tanks, etc. In the flow 100, the designing includes matching needed component specifications 132 with available components. The matching can include choosing a pressure vessel based on volume and pressure rating; choosing an additional liquid piston heat engine to provide stepped down pressure from the LPHE; matching a number of turbines to an amount of energy to be generated, etc. In the flow 100, the designing includes providing component dwell times 134. A component dwell time can include an amount of time that a component is enabled or disabled, engaged or disengaged, and so on. The dwell time of a component can be based on a number of hours that the component has been in service. In embodiments, the component dwell times can include valve open times, valve shut times, compressor run times, expander run times, turbine run times, actuator active times, and the like.

The flow 100 further includes generating control information 140 for the energy system plant design. The generated control information can be used by a component that can manage the operations of the energy system plant. The operations manager can enable and disable components, operate components based on a dwell time, and so on. In embodiments, the control information can be generated based on the specification. In a usage example, the specification can indicate that a backup or auxiliary energy system plant can be brought online when energy load requirements exceed a threshold percentage capacity of a main energy supply plant. The flow 100 further includes outputting 142 the control information. The control information can be output in the form of a high-level language code, a code that can be executed by a controller or energy system plant manager, and the like. In embodiments, the outputting the control information can enable energy system plant operation. Enabled operations of the energy system plant operation can include bringing components online or taking components offline, enabling and disabling components, operating valves, controlling an amount of energy that is stored or recovered, and the like.

The flow 100 further includes simulating 150 the energy system plant design. The simulating the design can accomplish evaluation of one or more designs, comparison of competing designs, and so on. The simulating can be based on executing code that can represent a design, simulating the design as a mechanical system, etc. The simulating can include simulating the energy system plant design at one or more levels of abstraction. The simulation can be used to determine the ability of a design to meet or exceed the set of energy system plant requirements that were obtained. In the flow 100, the simulating enables a reliability analysis 152. The reliability analysis can be used to estimate mean time to failure (MTTF) of one or more components based on predicted usage of the components per the design. In the flow 100, the simulating provides feedback 154 about the plant description. The feedback that is provided can include an ability of a design to meet the energy system plant requirements. The feedback can include a percentage, a value, a binary response such as “yes or no” or their numerical equivalents, etc. The feedback can suggest alternatives for components included in the design, additional components, a reduction of components, and the like. In the flow 100, the simulating provides feedback 154 about the plant description. The feedback can include qualitative responses such as feasible or infeasible, a numerical response, and so on. In the flow 100, the simulating generates operational controls 156 associated with an energy system plan design. The operational controls can include enabling or disabling one or more components, opening or closing valves, activating or deactivating backup energy sources, and so on. In the flow 100, the operational controls enable energy system plant functionality 158. The energy system plant functionality can include generating energy, harvesting excess energy, storing energy, converting energy, extracting stored energy, etc.

The flow 100 includes outputting an energy system plant design 160, based on the specification. The energy system plant design can include a software-defined, modular mechanical system. The energy system plant design that is output can include a description of components including a LPHE that comprise the design, the couplings between components, the control to operate the components and couplings, etc. Since the designed mechanical system is software-defined, the designs can be based on code, instructions, function or routine calls, and the like. In embodiments, the designing can include redundancy definitions. The redundancy definitions can include 1N, 1N+1, or 2N redundancy, etc. The redundancy definition can include a recommendation for a number of spares for components that can be difficult to obtain on short notice. In embodiments, the redundancy definitions can be based on the energy system plant requirements. The energy system plant requirements can define a level of redundancy, suggest or recommend a level of redundancy, etc. The level of redundancy can be based on a level of availability specified in the energy system plant requirements. In other embodiments, the redundancy definitions are based on component specifications. The redundancy definitions can include requiring one or more duplicates of a component or redundant components to reduce duty cycle, to operate a component at a target operating point, and the like.

In further embodiments, the component specifications can be updated based on field performance data. Designs are often generated based on historical, estimated, average, typical, or other data. Field performance data, which is derived from actual usage of an energy system plant, can be used to update, bolster, optimize, or otherwise modify or improve the design. In embodiments, the designing encompasses a design envelope. The design envelope can include a range over which an energy system plant can be expected to operate. The design envelope can include a range for energy generation, storage, extraction, and so on. The design envelope can include a duty cycle, a reliability, etc. In embodiments, the design envelope can include maximum power generation capability. The maximum power generation capability can include peak power generation, a continuous peak, a root-mean-square (RMS) value, and the like. The peak capability can further include other operations. In other embodiments, the design envelope can include maximum desalination capability. In the flow 100, the design enables energy system plant construction 162. As discussed previously and throughout, the design can include a components list, coupling specifications and configurations, and so on. The design can include a physical layout for the components and the couplings. The design can comprise a “blueprint” for the energy system plant.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

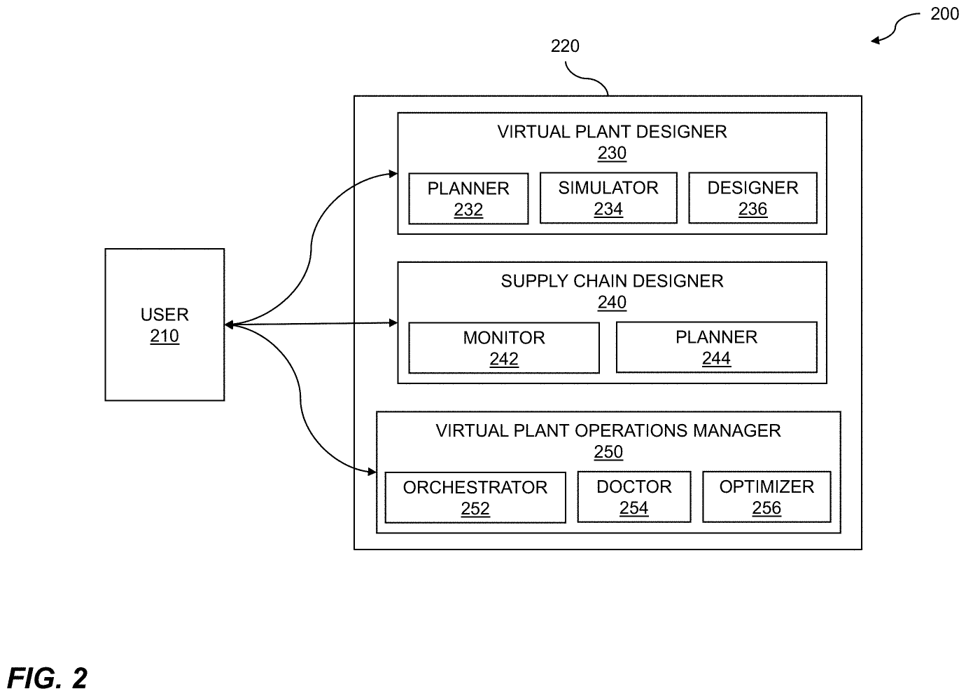

FIG. 2 illustrates an energy internet (EI) platform. Discussed throughout, the design of a modular energy system can be software-defined. The software-defined energy system can be based on a set of energy system plant requirements. Since the energy system is software-defined, changes, modifications, improvements, deletions, and so on, of energy system components can be accomplished by reprogramming, recoding, etc., the energy system design. Such programmatic changes enable competing energy plant designs to be compared. An energy internet platform can include a plurality of components that can accomplish a variety of virtual tasks. The virtual tasks can include energy system plant design, supply chain design, plant operations, and so on. An energy internet platform is based on software-defined modular energy system design and operation. A set of energy system plant requirements for a mechanical system is obtained, wherein the mechanical system comprises a plurality of components, wherein the plurality of components includes a liquid piston heat engine. One or more processors are used to optimize a plant description, wherein the plant description is based on the set of energy system plant requirements and a library of components. One or more processors are used to design a specification for an energy system plant, wherein the specification includes components from the library of components, along with couplings among the components. An energy system plant design is output, based on the specification, wherein the design enables energy system plant construction.

A block diagram for an energy internet (EI) platform is shown 200. A user 210 can interact with the EI platform 220. The user can include an energy system designer, an energy developer, an energy plant administrator, and so on. The user 210 can interact with the EI platform 220 using a window or tab associated with a web browser, an application or app on a computer, an app on a smartphone or tablet, and the like. The user can interact with the EI platform to accomplish a variety of energy system-related tasks. The energy system-related tasks that user can wish to accomplish can include automated design of an energy system, design of an intelligent supply chain, virtual plant operations management, etc. The EI platform can include a virtual plant designer (VPD) 230. The virtual plant designer can be operated by the user, can run in an automated mode, and so on. The VPD can include a variety of components that can enable virtual plant design. The components can include a planner 232. The planner can be used to configure energy system plant requirements for a mechanical system. The energy system plant requirements can be based on a software code, one or more specifications entered into a form, and so on. The components associated with the VPD can include a simulator 234. The simulator can simulate one or more plans generated by the planner. Simulations performed by the simulator can enable reliability analysis, provide feedback about the plant description, generate operational controls, and so on. The components associated with the VPD can include a designer 236. The designer can design a specification for an energy system plant. The specification that is designed can be simulated, where the results of the simulation can be compared to the configuration generated by the designer.

The energy internet platform can include a supply chain designer (SCD) 240. The SCD can be used to design, configure, update, edit, delete, and otherwise manipulate designs for supply chains. The supply chains can include one or more of energy supply chains, component supply chains, and so on. The SCD can design a supply chain based on preferences. The preferences can include energy source preferences such as sourcing energy from one or more renewable energy sources or backup energy sources, energy delivery requirements, energy reliability requirements, and the like. The SCD can include one or more components that can enable supply chain design. The supply chain design can include intelligent supply chain design. The components associated with the SCD can include a monitor 242. The monitor can monitor a supply chain for proper operation, delays, exceptions, opportunities, etc. The components associated with the SCD can include a planner 244. The planner can arrange sources, schedule component transportation, and the like.

The energy internet platform can include a virtual plant operations manager (VPOM) 250. The operations manager can control the operation of a software-define modular energy system plant. The operations of the plant can be based on an energy system plant design. In embodiments, simulating can generate operational controls. The operational controls can control various aspects of an energy system plant. In embodiments, the operational controls can enable energy system plant functionality. Energy plant functionality can include reliability, maximum downtime, redundancy, etc. Operational controls can include enabling and disabling energy sources, charging and discharging energy storage components, enabling and disabling backup energy sources, controlling energy distribution, and so on. The VPOM can include one or more components that can enable virtual energy plant operations. The components associated with the VPOM can include an orchestrator 252. The orchestrator can control and manage power sources, power distribution, power component enablement and disablement, valves, liquid piston heat engines, etc. The components associated with the VPOM can include a doctor 254. The doctor can troubleshoot energy system plant problems, propose solutions to detected problems, and so on. The components associated with the VPOM can include an optimizer 256. The optimizer can optimize operations of the virtual plant operations manager. Optimization can include balancing loads on energy sources, tracking in-service hours of components, overseeing routine maintenance, and so on.

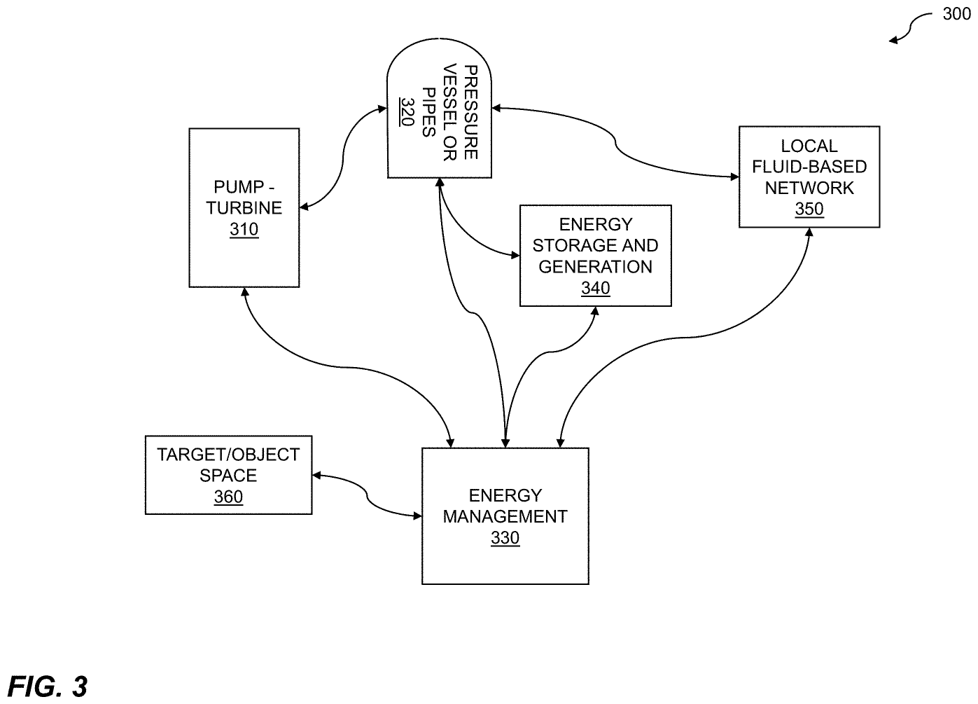

FIG. 3 is a block diagram for energy management. Energy management can be based on mechanical machines, where the mechanical machines can be based on software-defined modular energy systems. The software-defined modular energy systems can include utilizing a liquid to compress a gas, utilizing a gas to pressurize a liquid, and so on. The machines can include a converged infrastructure, where the converged infrastructure can include fluid-based assemblies for energy storage and generation. The fluid-based assemblies can include assemblies that use the compressed gas or the pressurized liquid. A set of energy system plant requirements is obtained for a mechanical system comprising a plurality of components that includes a liquid piston heat engine. Processors are used to optimize a plant description. The plant description is based on the set of energy system plant requirements and a library of components. Processors are used to design a specification for an energy system plant. The specification includes components from the library of components, along with couplings among the components. An energy system plant design is output, based on the specification, wherein the design enables energy system plant construction.

Energy management 300 can include a pump-turbine 310. In embodiments, the pump-turbine can comprise separate pump and turbine components, a combined pump-turbine component, etc. The pump-turbine can be coupled to a vessel. The vessel can comprise a pressure vessel or pressure pipes 320. Energy management can include more than one pump-turbine/pressure vessel or pressure pipes assembly. The pressure vessel can include an air compression tank, a cavern, unused oil infrastructure, and so on. The pressure pipes can include pressure amplification pipes.

The pump-turbine/pressure vessel or pipes assembly can be connected to an energy management component 330. The energy management component can include an energy control management system, where the energy control management system can include software that can be executed on one or more processors. The energy management component can be coupled to energy storage and generation 340. Various types of energy, such as electrical energy, chemical energy, thermal energy, kinetic energy, potential energy, etc., can be stored. Energy storage such as electrical energy storage can include batteries, capacitors, and so on. Fluid-based energy storage and generation assemblies can include multiple parallel pipes to accommodate fluid expansion or compression. The energy management can control the pump of the pump-turbine. In embodiments, at least one of the one or more fluid-based energy storage and generation assemblies includes a pump running at an optimum performance-pressure point. Other energy storage techniques can be used. When the energy being stored is electrical energy, the electrical energy can be converted between direct current (DC) electrical energy and alternating current (AC) electrical energy. Energy storage can be accomplished using flywheels which can be separate from or included as part of a motor or generator.

The energy management can include a local fluid-based network 350. The fluid-based network can include energy management, energy storage and generation, pressure vessels or pressure pipes, pump-turbines, and so on. The local fluid-based network can be used for delivering fluid-based energy. In embodiments, the delivering includes providing local, fluid-based services. The fluid-based services can include domestic services, industrial or manufacturing services, and the like. In embodiments, the local, consumer applications can include a water nozzle, an air nozzle, a water Venturi function, an air Venturi function, a vacuum supply, space heating, a fluid-based rotation, space cooling, hot water, or cold water. The delivering can provide other services such as motion services. In embodiments, the delivering includes providing a fluid-based equivalent mechanical range of motion through fluid transfer. The energy management can include a target/object space 360.

Fluid-based energy transfer can include conveying a fluid flow to a target object or target space. The conveyance of the fluid flow can be accomplished using ducts, pipes, Venturi functions, nozzles, and so on. In embodiments, the conveyance can include two-phase heterogeneous or two-phase homogeneous compression. A pump or pump-turbine can be used to pressurize water for example, where the pressurized water can be used to compress air or other gas. The pump or pump-turbine can be used to compress air or a gas, where the pressurized air or gas can be used to pressurize a liquid such as water.

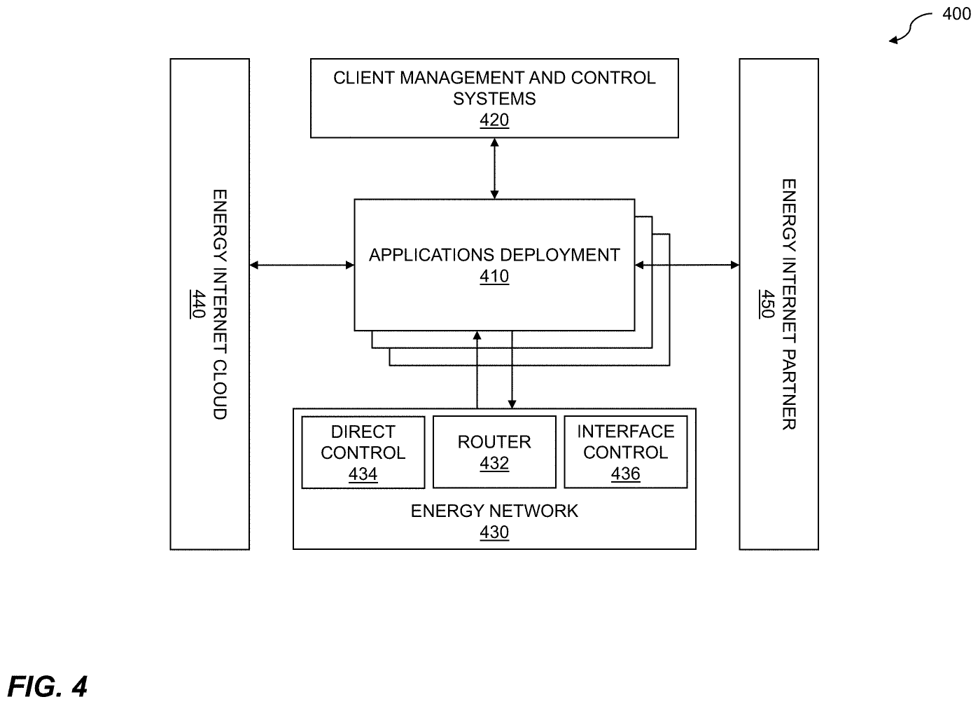

FIG. 4 illustrates an energy internet block diagram. An energy internet 400 enables energy management, where the energy management can be accomplished using software-defined modular energy systems. Energy management is further based on energy transfer through fluid flows, where the fluids can include compressed, liquefied gases, pressurized liquids, and so on. A set of energy system plant requirements is obtained for a mechanical system, wherein the mechanical system comprises a plurality of components, wherein the plurality of components includes a liquid piston heat engine. One or more processors are used to optimize a plant description, wherein the plant description is based on the set of energy system plant requirements and a library of components. One or more processors are used to design a specification for an energy system plant, wherein the specification includes components from the library of components, along with couplings among the components. An energy system plant design is output, based on the specification, wherein the design enables energy system plant construction.

The energy internet can include applications deployment 410. The applications deployment for an energy internet can include a cluster, where the cluster includes one or more application programming interfaces (APIs) for handling data, policies, communications, control, and so on. The data can include energy storage, pump-turbine storage, energy from waterpower, grid energy, etc. The data can include information from energy generators, partners, and so on. The data can further include third-party data from parties including energy consumers such as oil rigs; solar, wind, tidal, or wave-action farms; data centers; and the like.

Applications deployment can communicate with client management and control systems 420. The management can include infrastructure management, microgrid management, operating management, automated controls, and so on. The management can include management of client legacy equipment. The communicating of applications deployment with client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 430. The energy network can include one or more energy routers 432, direct control 434, interface control 436, and so on. An energy router 432 can include digital switches for routing energy from a point of energy generation to a point of energy load. An energy router can be coupled to one or more direct control 434 sensors for detecting switch status, point of source status, point of load status, etc. An energy router can be coupled to direct control actuators for steering energy from one or more points of source to a given point of load. An energy router can be further connected to one or more third-party interface control 436 sensors and third-party interface control actuators. The interface control sensors and interface control actuators can be coupled to equipment such as legacy equipment which may not be directly controllable.

The energy internet (EI) can include an energy internet cloud 440. The energy internet cloud can include an energy internet ecosystem, an energy internet catalog, and so on. The energy internet cloud can include an energy internet secure application programming interface (API) through which the EI cloud can be accessed. The EI ecosystem can include third-party applications such as an application or app store, app development and test techniques, collaboration, assistance, security, and so on. The EI cloud can include an EI catalog. The EI catalog can include technology models, plant and equipment information, sensor and actuator data, operation patterns, etc. The EI cloud can include tools or “as a service” applications such as learning and training, simulation, remote operation, and the like. The energy internet can include energy internet partners 450. The EI partners can provide a variety of support techniques including remote management, cloud support, cloud applications, learning, and so on.

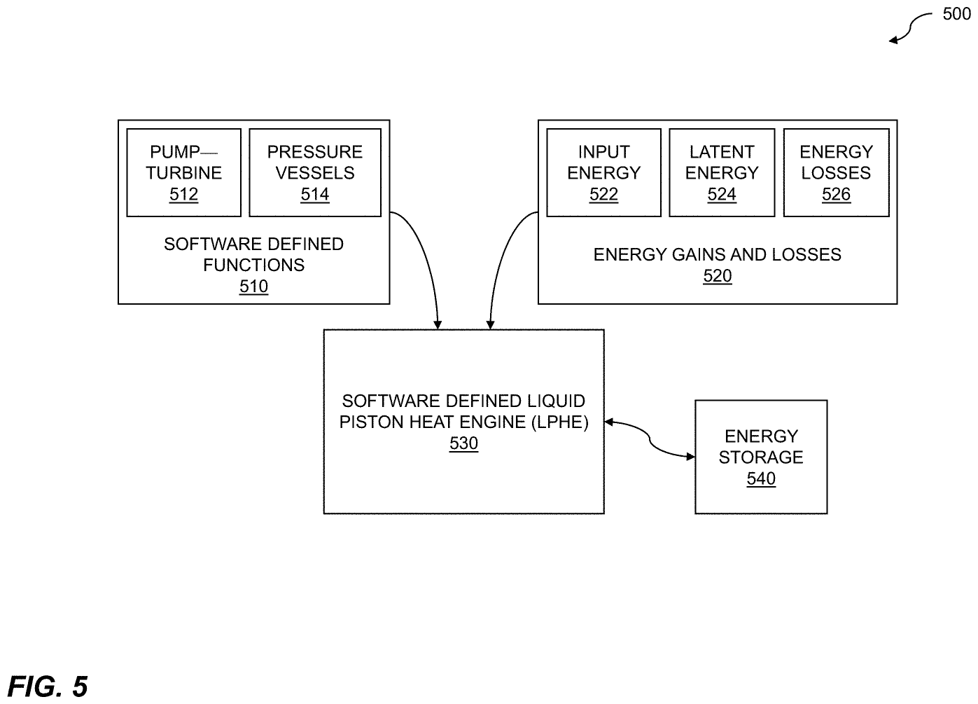

FIG. 5 shows a software-defined liquid piston heat engine. Energy can be generated, stored, recovered, transformed, delivered, and so on, to meet energy load requirements. At times, the energy load requirements can be dynamic. Energy storage can be performed when a surfeit of energy is being generated from energy sources including renewable energy sources such as wind, solar, tidal, wave-action, biogas, and so on. The energy can be stored on a short-term basis, such as a length of time substantially less than one week, or on a long-term basis, such as a length of time substantially more than one day. The energy transforming and delivering can be based on software-defined modular energy system design and operation. A set of energy system plant requirements is obtained for a mechanical system. The mechanical system comprises a plurality of components, where the components include a liquid piston heat engine. Processors are used to optimize a plant description. The plant description is based on the set of energy system plant requirements and a library of components. The processors are used to design a specification for an energy system plant. The specification includes components from the library of components, along with couplings among the components. An energy system plant design is output, based on the specification, wherein the design enables energy system plant construction. The energy plant that is designed can be used to deliver energy. In embodiments, the delivering includes providing local, fluid-based services, where the local, fluid-based services supply local consumer applications. The local consumer applications include a water nozzle, an air nozzle, a water Venturi function, an air Venturi function, a vacuum supply, space heating, a fluid-based rotation, space cooling, hot water, or cold water.

A software-defined liquid piston heat engine system 500 is shown. The liquid piston heat engine includes one or more software-defined functions 510. The one or more software-defined functions can configure or control energy management system components, subsystem components, etc. The software-defined functions can include a pump-turbine function 512. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 514. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The liquid piston heat engine can include energy gains and losses 520. Energy gains can include input energy 522. The input energy can include energy that can be input for storage. The input energy can include grid energy, locally generated energy, renewable energy, and so on. Energy gains can include latent energy 524. Latent energy can be captured from phase changes such as a change from a gas to a liquid, from a liquid to a solid, and so on. The latent energy can be stored. The liquid piston heat engine can include energy losses. Energy losses 526 can include pressure losses from pressurized vessels, temperature losses, electrical charge leakage, and so on. The system 500 includes a software-defined liquid piston heat engine (LPHE) 530. The software-defined LPHE can use software to configure the software-defined functions, to control energy storage and recovery, and so on. The LPHE can include an energy management system that can be operated by an energy management control system. The energy management control system can add or remove energy generation subsystems or energy storage subsystems as needed. The energy management control system can support hot swapping of one or more subsystems. Hot swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system, such as the fluid-based energy management system, includes storing energy for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time increments can be used. In other embodiments, the long-term basis can be an integer number of weeks, months, seasons, or years, wherein the integer number of weeks, months, seasons, or years comprises a length of time substantially more than one day.

The system 500 includes energy storage 540. Energy that can be stored can includes electrical energy, chemical energy, mechanical energy, fluid energy, gas energy, and so on. Energy can be stored using one or more of the energy storage and generation assemblies. In embodiments, energy storage and generation assemblies comprise multiple, parallel pipes to accommodate fluid expansion or compression. As discussed throughout, the pipes, including the parallel pipes, can include a high-pressure input pipe, a hierarchy of intermediate pressure pipe layers, low pressure storage pipes, and so on. In embodiments, the fluid of the one or more fluid-based energy storage and generation assemblies can include liquid air. Further liquids may also be used within the energy storage and generation assemblies. In other embodiments, the further liquids can include liquid nitrogen, Freon™, and the like. The LPHE liquid can comprise water such as fresh water, sea water, polluted water, wastewater, brine, and so on.

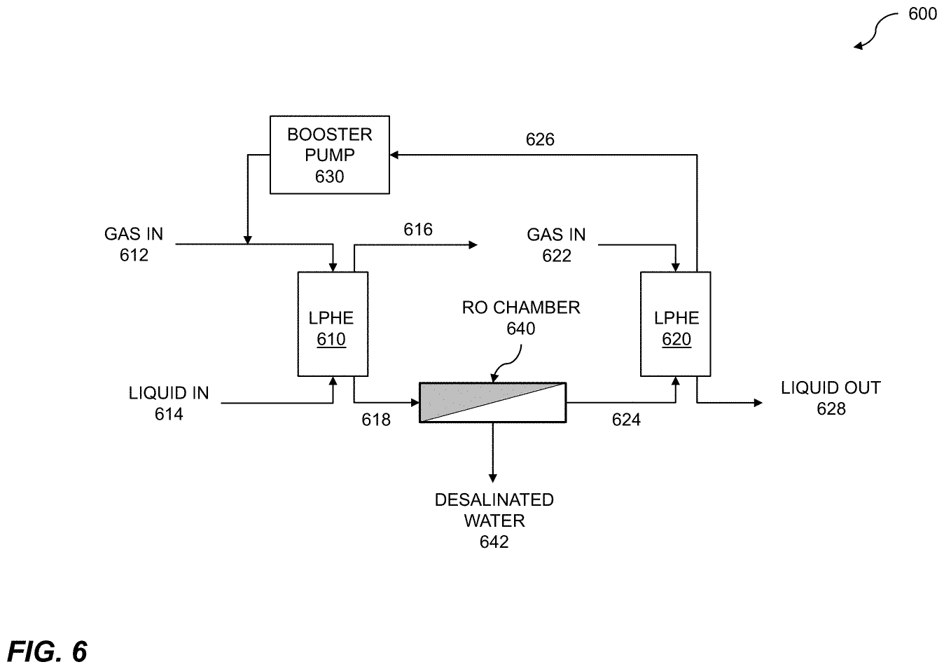

FIG. 6 illustrates a desalination system with brine recovery. The desalination system can be implemented using control and configuration of software-defined, modular machines. A set of energy system plant requirements is obtained for a mechanical system, wherein the mechanical system comprises a plurality of components, wherein the plurality of components includes a liquid piston heat engine. One or more processors are used to optimize a plant description, wherein the plant description is based on the set of energy system plant requirements and a library of components. One or more processors are used to design a specification for an energy system plant, wherein the specification includes components from the library of components, along with couplings among the components. An energy system plant design is output, based on the specification, wherein the design enables energy system plant construction.

The illustrative system 600 includes a liquid piston heat engine 610. The liquid piston heat engine LPHE enables transfer of work between gases and liquids with no mechanically moving parts. A Liquid In 614, such as sea water, is allowed to enter and fill LPHE 610 by appropriately opening and closing valves (not shown) on input and output lines to a first LPHE 610 (and a second LPHE 620, described later). Gas In 612, which is environmental air or other type of air, is pressurized to a high pressure, such as a pressure of 200 atmospheres, and it is allowed to enter LPHE 610 to pressurize the entrapped liquid, or in this case, sea water. The pressurized sea water 618 is then allowed to enter a reverse osmosis chamber 640, where the pressure will enable desalinated water 642 to exit chamber 640 and be used for any suitable freshwater application. In addition, brine 624 also exits the chamber 640. The brine 624 is “saltier” sea water, because fresh water has been extracted by the reverse osmosis of chamber 640. After some or all of the usable pressure contained in LPHE 610 is expended by moving pressurized sea water 618 through chamber 640, additional Liquid In 614 can be allowed to enter LPHE 610 as largely depressurized gas 616 is allowed to exit. Another pressurizing cycle can then commence.

Because the brine 624 leaving the chamber 640 has not been completely depressurized to ambient (atmospheric) pressure, work can be further recovered by allowing the brine to pressurize a gas within a second liquid piston heat engine 620. The gas in LPHE 620 is sourced from Gas In 622 and can also be environmental air. Alternatively, Gas In 622 can be sourced from the largely depressurized gas 616 of LPHE 610. In either case, brine 624 pressurizes the gas contained in LPHE 610, which is delivered as compressed gas 626 to booster pump 630, which can further compress the gas 626 until it achieves the same or similar pressure as Gas In 612, thus performing a brine work recovery function. Finally, the leftover brine within LPHE 620 is forced or allowed to drain out as Liquid Out 628, which can be introduced back into the source for Liquid In 614 (e.g., the ocean).

It should be noted that LPHE 610 and LPHE 620 can be operated in synchronization to provide efficient software-defined machine operation. It should be further noted that a LPHE operating in a compression mode can be cooled by a cooling liquid (e.g., water) internal spray to enable substantially isothermal operation. Likewise, a LPHE operating in an expansion mode can be heated by a warming liquid internal spray to enable substantially isothermal operation.

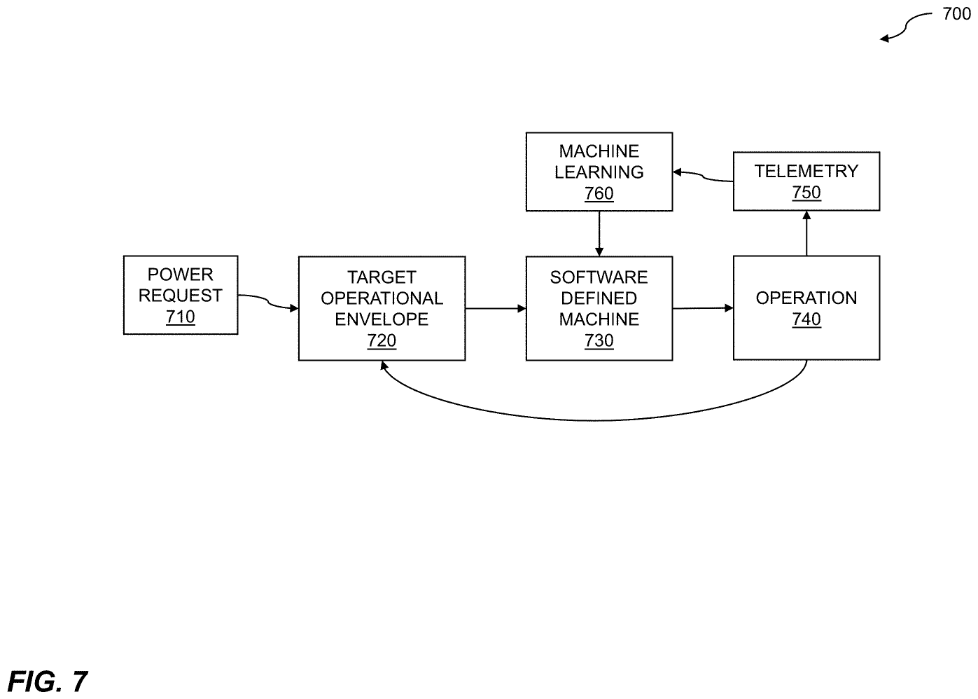

FIG. 7 shows a software-defined machine (SDM) application programming interface (API). A software-defined machine or SDM can enable a software-defined modular energy system. The software-defined machine can be controlled using a description language. The description language can include a high-level language such as a general-purpose language, a hardware description language designed for energy management, and so on. To provide access to the description language, an application programming interface or API can be provided. The API simplifies coding of the configuration and control of the SDM by providing commands, functions, routines, and so on, that can be coded directly or can be called from an application such as a third-party application. The SDM API enables software-defined modular energy system design and operation. A set of energy system plant requirements is obtained for a mechanical system, wherein the mechanical system comprises a plurality of components, wherein the plurality of components includes a liquid piston heat engine. One or more processors are used to optimize a plant description, wherein the plant description is based on the set of energy system plant requirements and a library of components. One or more processors are used to design a specification for an energy system plant, wherein the specification includes components from the library of components, along with couplings among the components. An energy system plant design is output, based on the specification, wherein the design enables energy system plant construction.

A software-defined machine application programming interface is shown 700. A power request 710 is received. The power request can be based on current power requirements, anticipated or peak requirements, contractual power requirements, and so on. The power request can be used to develop a target operational envelope 720. In order to attain the target operational envelope, a design envelope can be proposed. The design envelope can be used to design software-defined power generation systems, software-defined desalination systems, and so on. In embodiments, the design envelope can include a maximum power generation capability or a maximum desalination capability. The design envelope can be used to propose a software-defined machine 730. The proposed software-defined machine can be based on components, couplings between components, and so on. The components can include a liquid piston heat engine. The operation 740 of the proposed software-defined machine can be put into “operation”. In the context of developing the software-defined machine, the operation of the proposed design can be based on one or more simulations. The operating characteristics of the software-defined machine, whether in operation or being simulated, can be measured based on telemetry 750. The telemetry can be used to measure power provided, power needed, operations of the software-defined machine such as a valve opening and closing, an amount of time that a valve is open or closed, pressure within a pressure vessel (PV), and so. The data collected by the telemetry can be provided for machine learning 760. The machine learning can be used to “tune” or optimize the software-defined machine 730. In embodiments, the hardware description language can provide for self-learning management of the mechanical system. The self-learning management can be used to adapt the software-defined machine for faster response to power load needs, more efficient use of components, and the like. In other embodiments, the hardware description language can be used within a machine learning context. The machine learning context can include deep learning. The operation 740 can be used to update the target operational envelope. The various steps can be repeated in part or in whole to improve the software-defined machine.

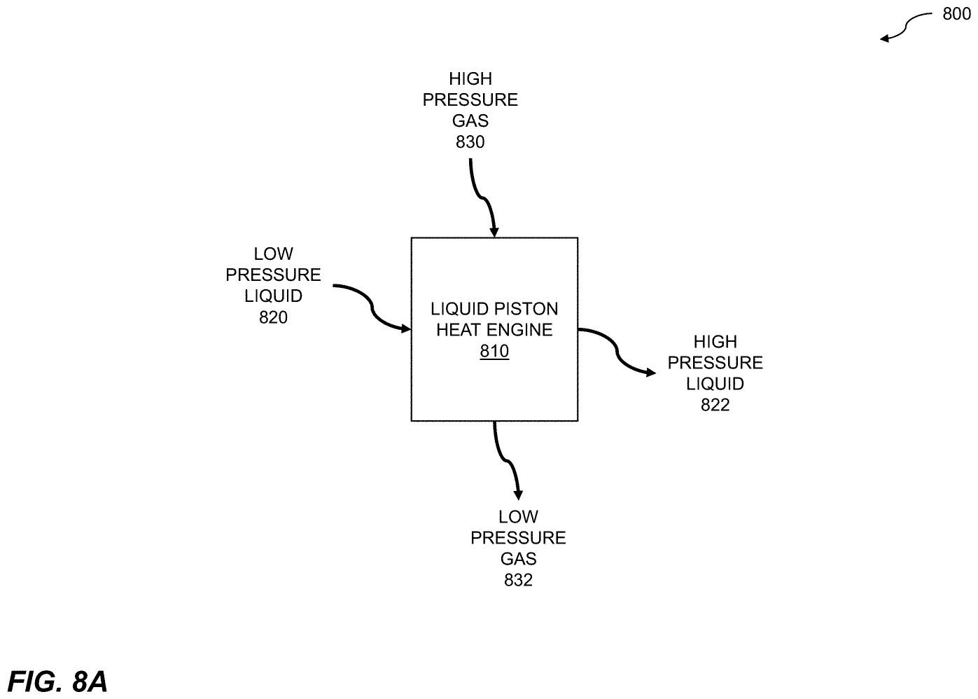

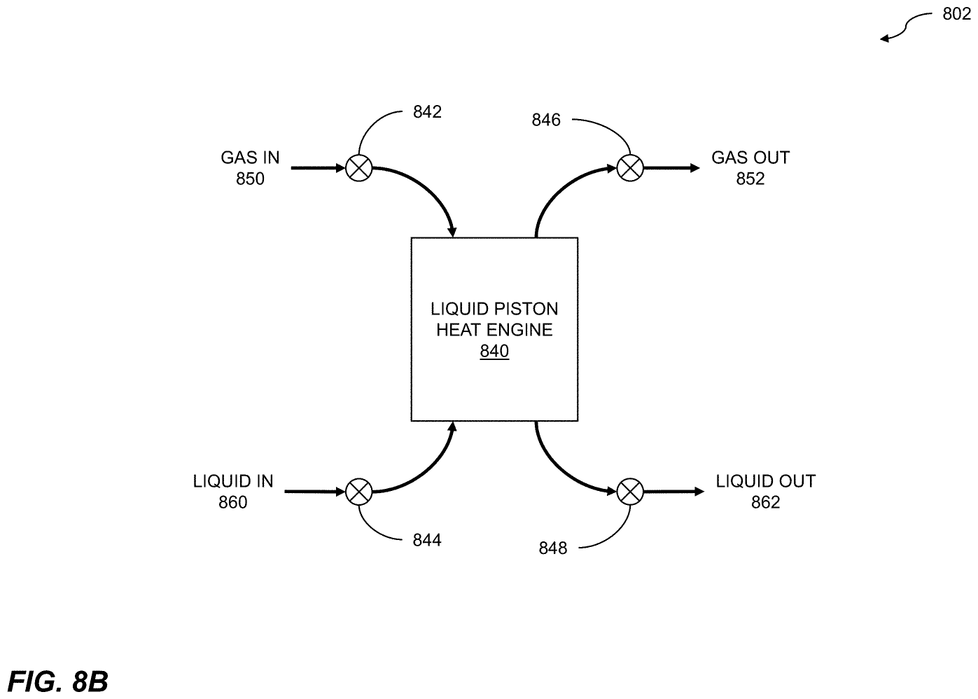

FIG. 8A illustrates a liquid piston heat engine (LPHE) to pressurize a liquid. The liquid piston heat engine can include a software-defined LPHE. In embodiments, the LPHE can include a water piston heat engine (WPHE), where the liquid comprises one or more types of water, such as fresh water, well water, sea water, recovered water, etc. The software-defined LPHE can use code to configure the software-defined functions, to control energy storage and recovery, and so on. The LPHE can include an energy management system that can be operated by an energy management control system. The energy management control system can be software-defined. The energy management control system can add or remove energy generation subsystems or energy storage subsystems as needed. The LPHE can be a component of a software-defined modular energy system. The liquid piston heat engine is based on a design and operation of software-defined modular mechanical machine. The software definition can be accomplished using a description language. A set of energy system plant requirements is obtained for a mechanical system that comprises a plurality of components including a liquid piston heat engine. Processors are used to optimize a plant description based on the set of energy system plant requirements and a library of components. The processors are used to design a specification for an energy system plant. The specification includes components from the library of components, along with couplings among the components. An energy system plant that enables energy system plant construction design is output.

A liquid piston heat engine (LPHE) 810 can use a liquid to compress a gas or a gas to pressurize a liquid. A LPHE that uses a gas to pressurize a liquid is shown 800. A low-pressure liquid 820 such as water, liquid air, liquid nitrogen, and so on, can be provided to the LPHE. A high-pressure gas 830, where the gas can include air, nitrogen, etc., can also be provided to the LPHE. The high-pressure gas can be used to pressurize the liquid, where the pressurizing the liquid can be accomplished in a pressure vessel associated with the LPHE. The pressurized liquid 822 is available at an output of the LPHE. The pressurized gas can exit the LPHE as a low-pressure gas 832.

FIG. 8B illustrates a logical model of a liquid piston heat engine 802. A logical model can be created, where the logical model can be associated with a software-defined modular energy system design that is based on a mechanical system. The software-defined modular energy system can be designed by obtaining a set of energy system plant requirements for a mechanical system. The mechanical system is based on components including a liquid piston heat engine. Couplings are described between the plurality of components. The logical model can use a description language to describe various components. In the example shown, the components can include a liquid piston heat engine 840 and valves such as 842, 844, 846, and 848. The valves can include smart valves. The logical model can further include inputs and outputs such as Gas In 850, Gas Out 852, Liquid In 860, and Liquid Out 862. The logical model can describe how the liquid can be used to compress the gas, the gas can be used to pressurize the liquid, etc. The software-defined machine uses a ruleset. The ruleset can include a system state table, a timing table, an event table, and a valve table. The software-defined machine ruleset can further include a software-defined machine state table. The state table can include states such as breathe, compress, egress, drain, etc. The timing table can include start times and end times. The start time and end time pairs can be associated with state vector entries such as a start time and an end time pair for a breathe state. The event table can include events such as energy available for storage, power load spikes, component outages, and the like. The state machine can be based on code written in the description language to control the software-defined machine.

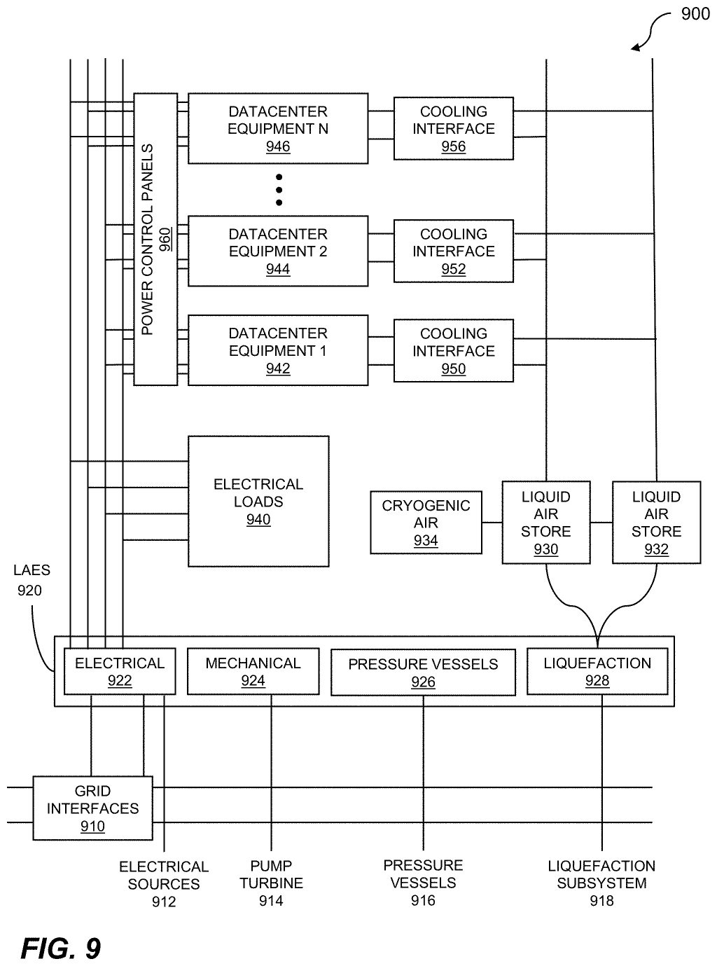

FIG. 9 shows example power distribution. Power can be generated and distributed using a mechanical system, where the mechanical system is based on a software-defined modular energy system. The operation of the software-defined modular energy system can be controlled using generated control information that is based on a specification. The power that is distributed can include electrical power such as grid power, power recovered from storage, and so on. Power distribution can be accomplished using control and configuration of software-defined modular mechanical machines. A set of energy system plant requirements is obtained for a mechanical system comprising a plurality of components that include a liquid piston heat engine. One or more processors are used to optimize a plant description that is based on the set of energy system plant requirements and a library of components. One or more processors are used to design a specification for an energy system plant, wherein the specification includes components from the library of components, along with couplings among the components. An energy system plant design is output based on the specification, wherein the design enables energy system plant construction.

Example power distribution 900 can include one or more grid interfaces 910. Grid interfaces can include interfaces to power, where the power can include commercially generated “grid” power, renewable power, locally generated power or “microgrid” power, and so on. Other sources of power, in addition to those coupled through the one or more grid interfaces, can be included. The energy sources can include electrical sources 912. The electrical sources can include diesel-generator (DG) sets, uninterruptable power supplies (UPSs), batteries, supercapacitors, and so on. The energy sources can include pump-turbine sources 914. A pump-turbine can pump a gas or a liquid, or the pump-turbine can use a gas or a liquid to generate electrical energy. The energy sources can include pressure vessel sources 916. The pressure vessel sources can provide a compressed gas, a pressurized liquid, etc. The energy sources can include a liquefaction subsystem source 918. The liquefaction subsystem source can be based on a liquefied gas such as liquefied air. The liquefaction source can be coupled to one or more liquid air stores such as liquid air store 930 and liquid air store 932. The one or more liquid air stores can be further coupled to cryogenic air 934, where the cryogenic air can be used to maintain the liquid air in the one or more liquid air stores.

The power provided via the grid interfaces and energy provided from the electrical, pump-turbine, pressure vessel, or liquefaction sources can be provided to liquid air energy storage (LAES) 920. The LAES can include energy storage and recovery components. The storage and recovery components can include electrical components 922, mechanical components 924, pressure vessels 926, and liquefaction components 928. The mechanical components, pressure vessels, and liquefaction components can be used to convert their stored energy to electrical energy. The LAES can provide power to electrical loads 940. The electrical loads can include electrical equipment such as computing, storage, and communications equipment; heating, cooling, and ventilation (HVAC) equipment; power distribution equipment; and the like. The electrical loads can include datacenter equipment located in datacenter or IT racks such as datacenter equipment 1 942, datacenter equipment 2 944, data center equipment N 946, etc. The liquid air within the one or more liquid air stores can be used to provide cooling to equipment within datacenter racks. The liquid air cooling can be provided using one or more cooling interfaces such as cooling interface 950, cooling interface 952, cooling interface 956, and so on. A cooling interface can provide one or more “cooling circuits” within a datacenter equipment rack. Each datacenter equipment rack is coupled to electrical sources using one or more power control panels 960. The power control panels can include switches, smart switches, etc.

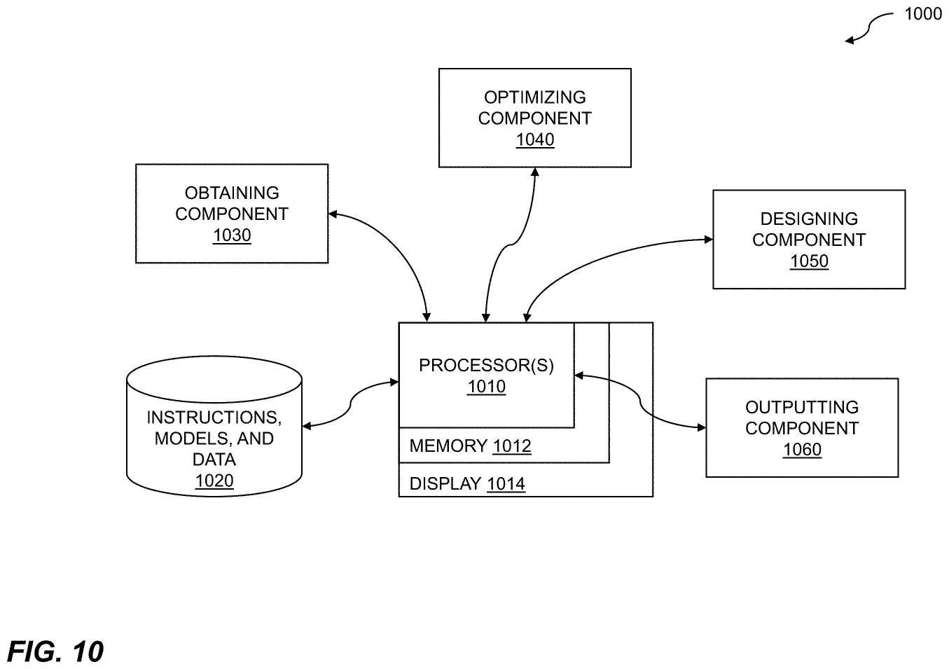

FIG. 10 is a system diagram for software-defined modular energy system design and operation. Energy system design is based on a software-defined modular system design, where the software-defined design enables modular energy system operation. A set of energy system plant requirements for a mechanical system are obtained. The requirements can include energy generation, storage, and reliability requirements. The mechanical system comprises a plurality of components such as generation, storage, transfer, and control components. A plant description is optimized using one or more processors. The plant description is based on the set of energy system plant requirements and a library of components. The processors are used to design a specification for an energy system plant. The specification can include capacity, redundancy, and reliability parameters. The specification includes components from the library of components, along with couplings among the components. An energy system plant design is output. The energy system plant design is based on the specification, and the design enables energy system plant construction. The energy system plant design is simulated. The simulating can be used to verify that requirements such as energy generation, energy storage, and energy delivery requirements are met by a design. The simulating enables a reliability analysis. The reliability analysis can be used to make decisions about component redundancy in the design and spares-on-hand requirements. The simulating generates operational controls, where operational controls enable energy system plant functionality. Control information is generated for the energy system plant design, based on the specification. The control information is output, where the control information enables energy system plant operation. The modular system design comprises a mechanical system, where the mechanical system is based on various components. The components include a liquid piston heat engine (LPHE).

The system 1000 can include one or more processors 1010 and a memory 1012 which stores instructions. The memory 1012 is coupled to the one or more processors 1010, wherein the one or more processors 1010 can execute instructions stored in the memory 1012. The memory 1012 can be used for storing instructions; for storing databases of energy subsystems, modules, or peers for system support; for storing energy system plant requirements, optimized plant descriptions, energy system plant designs, and simulation results; and the like. Information regarding operational controls that enable energy system plant functionality can be shown on a display 1014 connected to the one or more processors 1010. The display can comprise a television monitor, a projector, a computer monitor (including a laptop screen, a tablet screen, a netbook screen, and the like), a smartphone display, a mobile device, or another electronic display. The system 1000 includes instructions, models, and data 1020. The data can include information on energy sources, energy conversion requirements, metadata about energy, and the like. In embodiments, the instructions, models, and data 1020 are stored in a networked database, where the networked database can be a local database, a remote database, a distributed database, and so on. The instructions, models, and data 1020 can include operational control of a mechanical system associated with an energy system. The instructions can further include instructions for obtaining energy system plant requirements. The instructions, models, and data can further include optimization data associated with one or more optimized plant descriptions. The instructions, models, and data can include instructions for designing a specification for an energy system plant. The specification that is designed includes components from the library of components, along with couplings among the components. The instructions, models, and data can further include simulation results. The simulation results can include reliability analysis, feedback about a plant description, generated operational controls, and so on.

The system 1000 includes an obtaining component 1030. The obtaining component 1030 can obtain a set of energy system plant requirements for a mechanical system. The mechanical system can include a system for energy generation, storage, distribution, and management. The mechanical system can include a plurality of components. The components can include energy generation, energy storage, energy conversion, energy distribution components, and so on. The plurality of components includes a liquid piston heat engine (LPHE). The mechanical system can be based on a modular energy system, where the modular energy system is software-defined. The software-defined module energy system can include a fluid-based local energy generation, storage, and transfer distribution system. The fluid-based system can compress a gas, pressurize a liquid, and so on. The fluid-based system can include a high-pressure vessel, a pump-turbine, valves, and so on. The fluid-based system can be based on a homogeneous fluid. The homogeneous fluid can include more than one phase such as a homogeneous fluid in liquid and gaseous phases. In embodiments, the software-defined machine can describe utilizing a liquid to compress a gas. The pressurizing the gas can include liquefying the gas. In other embodiments, the software-defined machine can describe utilizing a gas to pressurize a liquid. The pressurized liquid can be used to store energy such as excess energy from renewable sources. The pressurized liquid can be used to recover stored energy by spinning a turbine. The fluid-based system can be based more than one fluid. In embodiments, the fluid-based system can include at least two heterogeneous fluids. The liquid or liquids can include a variety of liquids such as liquid air, where the liquid air can be stored at a temperature less than −215° C.

In embodiments, the mechanical system can include energy storage. The energy storage can be based storing electrical energy, mechanical energy, chemical energy, thermal energy, kinetic energy. The energy can be stored as a compressed gas or pressurized liquid. In other embodiments, the mechanical system can further include energy generation. The energy generation can include electrical energy generation based on spinning a turbine, a pump-turbine, etc. In embodiments, the hardware design can include a plurality of constraints for the mechanical system or components. The constraints can be based on cost, a contractual agreement, a service level agreement, component capabilities, and the like. In other embodiments, the hardware design can include a plurality of goals for the mechanical system. The goals can include generation cost, average load, peak load, seasonal load, etc.

The system 1000 includes an optimizing component 1040. The optimizing component 1040 can optimize, using one or more processors, a plant description. The optimization of the plant description can be based on maximizing power generation, storage, and transfer efficiency; minimizing component count; minimizing cost; and so on. The optimization can be based on a variety of techniques such as continuous, discrete, unconstrained, deterministic, stochastic, and so on. The optimization can be based on solving an optimization function, using a solver application, etc. In the system 1000, the plant description is based on the set of energy system plant requirements and a library of components. The library of components can include energy components such as energy sources, energy storage components, energy transfer components, energy converters, energy managers, and so on. The library of components can include a liquid piston. In embodiments, the liquid piston can include a liquid piston heat engine. In other embodiments, the components can include pressure vessels, valves, smart valves, turbines, pumps, and so on.

The system 1000 includes a designing component 1050. The designing component can design, using one or more processors, a specification for an energy system plant, wherein the specification includes components from the library of components, along with couplings among the components. The specification can include a number and one or more types of components from the library of components. The specification can describe the coupling together of the components to form a software-defined modular system. The designed system can be simulated. The simulating can enable reliability analysis for an energy system plant. The reliability can include an uptime percentage, an amount of offline time, and the like. In embodiments, the simulating can provide feedback about the plant description. The feedback can identify design flaws, recommend configuration changes, propose redundancy levels, etc. In embodiments, the simulating generates operational controls for the energy system plant. The operational controls that are generated can enable energy system plant functionality. In embodiments, the designing can include matching needed component specifications with available components. Since the design that is implemented can be dynamic, the design can be updated based on changes to energy sources, storage availability, energy generation requirements, etc.

The system 1000 includes an outputting component 1060. The outputting component 1060 can output an energy system plant design, based on the specification. The plant design that is output can comprise a software-based modular energy plant design that can be based on a software-defined modular design. The design can include a “parts list” of components from the library of components, details about coupling the components together, and so on. In the system 1000, the design enables energy system plant construction. Further embodiments include outputting the control information. The control information can be used to turn on and turn off pumps and turbines, to open or close valves such as smart valves, to enable or disable energy sources, to manage energy delivery to loads, etc. In other embodiments, the outputting the control information enables energy system plant operation. The outputting can include outputting code, where the code can include a general-purpose language such as C, C++, or Python, or a language designed for power management and control. In embodiments, the energy system plant design that is output can describe utilizing a liquid to compress a gas. The compression can occur in a liquid piston such as a liquid piston heat engine. The gas can include air, nitrogen, or other suitable gas. In other embodiments, the software-defined machine can describe utilizing a gas to pressurize a liquid. The liquid can include water, seawater, and so on. The liquid can include a liquefied gas such as liquid air, liquid nitrogen, Freon™, and the like. The energy system plant design that is output can include detailed energy system control information. In embodiments, the implementing can include providing valve open times, redundancy definitions, or a design envelope. The valve open times can be based on energy needs, valve capabilities, etc. The redundancy definitions can include redundancy such as N+1, 2N, and the like. The redundancy definitions can include safety margins. In other embodiments, the design envelope can include a maximum power generation capability or a maximum desalination capability.

The system 1000 can include a computer system for energy system design comprising: a memory which stores instructions; one or more processors coupled to the memory wherein the one or more processors, when executing the instructions which are stored, are configured to: obtain a set of energy system plant requirements for a mechanical system, wherein the mechanical system comprises a plurality of components, wherein the plurality of components includes a liquid piston heat engine; optimize, using one or more processors, a plant description, wherein the plant description is based on the set of energy system plant requirements and a library of components; design, using one or more processors, a specification for an energy system plant, wherein the specification includes components from the library of components, along with couplings among the components; and output an energy system plant design, based on the specification, wherein the design enables energy system plant construction. Disclosed embodiments include a computer program product embodied in a non-transitory computer readable medium for energy system design, the computer program product comprising code which causes one or more processors to perform operations of: obtaining a set of energy system plant requirements for a mechanical system, wherein the mechanical system comprises a plurality of components, wherein the plurality of components includes a liquid piston heat engine; optimizing, using one or more processors, a plant description, wherein the plant description is based on the set of energy system plant requirements and a library of components; designing, using one or more processors, a specification for an energy system plant, wherein the specification includes components from the library of components, along with couplings among the components; and outputting an energy system plant design, based on the specification, wherein the design enables energy system plant construction.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for energy system design comprising:
obtaining a set of energy system plant requirements for a mechanical system, wherein the mechanical system comprises a plurality of components, wherein the plurality of components includes a liquid piston heat engine;
optimizing, using one or more processors, a plant description, wherein the plant description is based on the set of energy system plant requirements and a library of components;
designing, using one or more processors, a specification for an energy system plant, wherein the specification includes components from the library of components, along with couplings among the components; and
outputting an energy system plant design, based on the specification, wherein the design enables energy system plant construction.

2. The method of claim 1 further comprising generating control information for the energy system plant design.

3. The method of claim 2 wherein the control information is generated based on the specification.

4. The method of claim 2 further comprising outputting the control information.

5. The method of claim 4 wherein the outputting the control information enables energy system plant operation.

6. The method of claim 1 further comprising simulating the energy system plant design.

7. The method of claim 6 wherein the simulating enables a reliability analysis.

8. The method of claim 6 wherein the simulating provides feedback about the plant description.

9. The method of claim 6 wherein the simulating generates operational controls.

10. The method of claim 9 wherein the operational controls enable energy system plant functionality.

11. The method of claim 1 wherein the set of energy system plant requirements comprises a plurality of constraints for the mechanical system.

12. The method of claim 1 wherein the set of energy system plant requirements comprises a plurality of constraints for the components.

13. The method of claim 1 wherein the set of energy system plant requirements comprises a plurality of goals for the mechanical system.

14. The method of claim 13 wherein the plurality of goals includes a primary goal and a secondary goal.

15. The method of claim 14 wherein the primary goal includes desalination.

16. The method of claim 15 wherein the secondary goal includes gas compression.

17. The method of claim 1 wherein the components comprise pressure vessels, valves, turbines, or pumps.

18. The method of claim 1 wherein the designing includes matching needed component specifications with available components.

19. The method of claim 1 wherein the designing includes providing component dwell times.

20. The method of claim 19 wherein the component dwell times include valve open times, valve shut times, compressor run times, expander run times, turbine run times, and actuator active times.

21. The method of claim 1 wherein the designing includes redundancy definitions.

22. The method of claim 21 wherein the redundancy definitions are based on component specifications.

23. The method of claim 22 wherein the component specifications are updated based on field performance data.

24. The method of claim 1 wherein the designing encompasses a design envelope.

25. A computer program product embodied in a non-transitory computer readable medium for energy system design, the computer program product comprising code which causes one or more processors to perform operations of:
obtaining a set of energy system plant requirements for a mechanical system, wherein the mechanical system comprises a plurality of components, wherein the plurality of components includes a liquid piston heat engine;
optimizing, using one or more processors, a plant description, wherein the plant description is based on the set of energy system plant requirements and a library of components;
designing, using one or more processors, a specification for an energy system plant, wherein the specification includes components from the library of components, along with couplings among the components; and
outputting an energy system plant design, based on the specification, wherein the design enables energy system plant construction.

26. A system for energy system design comprising:
a memory which stores instructions;
one or more processors coupled to the memory wherein the one or more processors, when executing the instructions which are stored, are configured to:
obtain a set of energy system plant requirements for a mechanical system, wherein the mechanical system comprises a plurality of components, wherein the plurality of components includes a liquid piston heat engine;
optimize, using one or more processors, a plant description, wherein the plant description is based on the set of energy system plant requirements and a library of components;
design, using one or more processors, a specification for an energy system plant, wherein the specification includes components from the library of components, along with couplings among the components; and
output an energy system plant design, based on the specification, wherein the design enables energy system plant construction.
